(19) United States
(12) Patent Application Publication
(10) Pub. No.: US 2016/0007201 A1
(43) Pub. Date: Jan. 7, 2016

(54) VPN-BASED MOBILE DEVICE SECURITY

(71) Applicant: Telmate, LLC, San Francisco, CA (US)

(72) Inventors: Richard Torgersrud, SAN FRANCISCO, CA (US); Grant Gongaware, Alameda, CA (US); Joseph Savona, San Francisco, CA (US); Nicolas Garcia, Castro Valley, CA (US)

(21) Appl. No.: 14/810,475

(22) Filed: Jul. 27, 2015

Related U.S. Application Data
(60) Provisional application No. 62/003,458, filed on May 27, 2014.

(51) Int. Cl. H04W 12/08; H04L 29/06; H04W 12/06

(52) U.S. Cl. CPC H04W 12/08; H04W 12/06; H04L 63/0876

(57) ABSTRACT

A method for providing VPN-based mobile device security is provided. The method includes receiving a login connection request from a mobile device that includes a login credential based in part on a pre-assigned mobile device MAC address and validating the login connection request if a USERID portion of the login credential matches to a registered user and if the pre-assigned MAC address portion of the login credential matches a MAC address of the mobile device that sent the login connection request. Also, if the login connection request successfully validates, allowing access to white-listed content.

### CROSS-REFERENCE TO RELATED APPLICATIONS

This application hereby claims the benefit of priority of U.S. Provisional Patent Application Ser. No. 62/003,458, filed on May 27, 2014, entitled “VPN-BASED TABLET SECURITY’ and is herein incorporated by reference.

### BACKGROUND

In a secure facility, such as a prison, that allows use of data devices by residents, there is a need to control connections to the data devices as well as the content and/or the type of content. Prior art attempts at providing to provide such functionality often fail to deliver in many aspects and as a result are not optimal in a secure facility-type environment.

The foregoing examples of the related art and limitations related therewith are intended to be illustrative and not exclusive. Other limitations of the related art will become apparent to those of skill in the art upon a reading of the specification and a study of the drawings.

### SUMMARY

A method for providing VPN-based mobile device security is provided. The method includes receiving a login connection request from a mobile device that includes a login credential based in part on a pre-assigned mobile device MAC address and validating the login connection request if a USERID portion of the login credential matches to a registered user and if the pre-assigned MAC address portion of the login credential matches a MAC address of the mobile device that sent the login connection request. Also, if the login connection request successfully validates, allowing access to white-listed content.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 shows a system in accordance with one or more embodiments of the invention.

FIG. 2 shows a diagram of a server system in accordance with one or more embodiments of the invention.

FIG. 3 shows a diagram of a kiosk in accordance with one or more embodiments of the invention.

FIG. 4 shows a computer system in accordance with one or more embodiments of the invention.

FIG. 5 shows a mobile device in accordance with one or more embodiments of the invention.

FIGS. 6-9 illustrate aspects of security access control software.

FIG. 10 is a flowchart diagram illustrating a method for VPN-based mobile device security.

### DETAILED DESCRIPTION

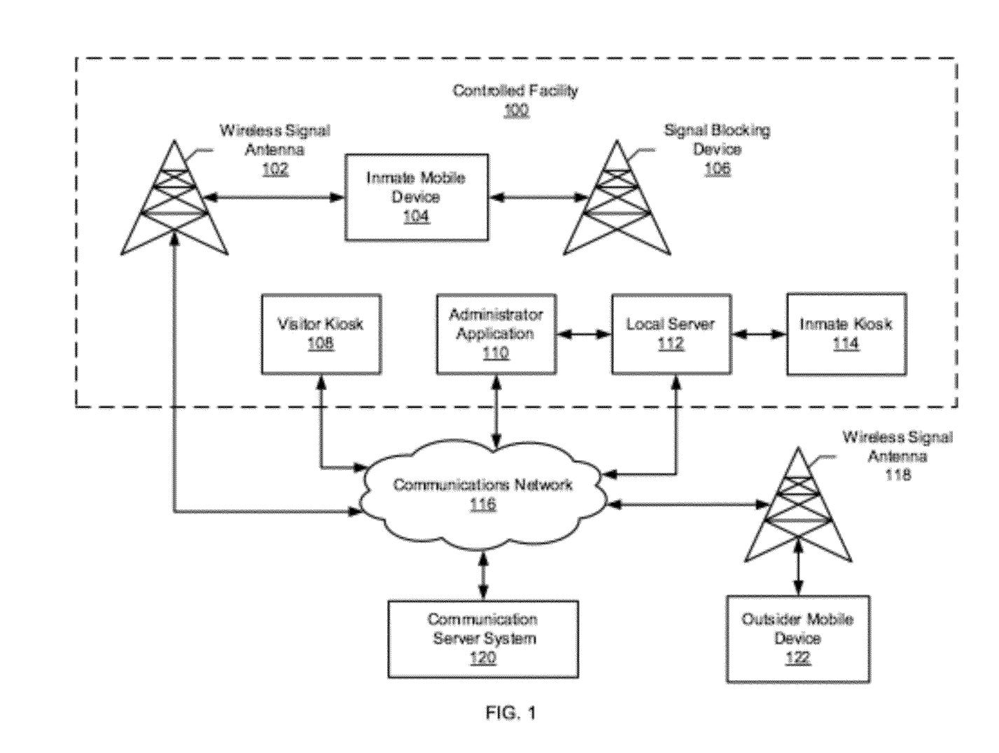

FIG. 1 shows a diagram of a system in accordance with one or more embodiments of the invention. As shown in FIG. 1, the system includes a controlled facility (100), two wireless signal antennas (wireless signal antenna (102) and wireless signal antenna (118)), an inmate mobile device (104), a signal blocking device (106), a visitor kiosk (108), an administrator application (110), a local server (112), an inmate kiosk (114), a communications network (116), a communication server system (120) and visitor mobile device (122).

In one or more embodiments of the invention, a controlled facility (100) is an access-restricted location in which an inmate resides. Examples of controlled facilities (e.g., controlled facility (100)) include, but are not limited to, detention environments (e.g., jails, prisons, etc.), immigration detention centers, military centers, government secure sites, law enforcement holding structures, and psychiatric hospitals.

In one or more embodiments of the invention, an inmate is a resident of a controlled facility (100) and is subject to one or more restrictions, primarily to his or her freedom or rights. Such restrictions may be part of a court-imposed sentence on an inmate, while others may be specific to the controlled facility (100) in which the inmate resides. Restrictions may include limitations on an inmate's physical movement (i.e., physical restrictions) and limitations on the inmate's ability to communicate (Le., communication restrictions). Communication restrictions include inmate use restrictions, inmate target restrictions, and device use restrictions.

In one or more embodiments of the invention, inmate use restrictions are limitations on an inmate's general ability to communicate with visitors and/or outsiders. Inmate use restrictions may include, for example, periods of time in which an inmate is not allowed to communicate with outsiders or visitors (e.g., between 10 PM and 8 AM, during an imposed one-week punitive period, etc.) and limitations based on lack of funds (e.g., insufficient commissary account balance to initiate a communication).

In one or more embodiments of the invention, inmate target restrictions are limitations on the target or source of a communication with the inmate. Inmate target restrictions may be specific outsiders or visitors with whom the inmate is not allowed to communicate (e.g., the victim of a crime perpetrated by the inmate, etc.). Inmate target restrictions may also include types of people with whom the inmate is not allowed contact (e.g., outsiders who are ex-cons, minors under the age of 18, etc.).

In one or more embodiments of the invention, device use restrictions are restrictions based on the condition or state of the communication device used by the inmate. Device use restrictions include, for example, limitations based on the location of the inmate's mobile device, limitations imposed based on a determination that the device has been tampered with, etc.

In one or more embodiments of the invention, an outsider is a person outside the controlled facility (100) who may be the source or target of a communication with an inmate. An outsider who enters the controlled facility (100) for the purpose of communicating with an inmate is referred to as a visitor.

In one or more embodiments of the invention, wireless signal antenna (102) and/or wireless signal antenna (118) are antennas used to propagate wireless signals. The wireless signals may be of any strength and type now known or later developed.

In one or more embodiments of the invention, the inmate mobile device (104) is a device with functionality to send and receive audio communications between an inmate and an outsider or visitor. For example, inmate mobile device (104) may be a computing device such as a smart phone, laptop, tablet, or other suitable device. Specifically, the inmate mobile device (104) may be used to send or receive text messages and/or initiate or receive voice or video calls. In one embodiment of the invention, the inmate mobile device (104) also enables an inmate to access a secure social network. Specifically, the inmate mobile device (104) may be used to upload media to, or view media from, a secure social network account of the inmate or another secure social network member. In one or more embodiments of the invention, inmate mobile device (104) executes an inmate application (not shown) that provides the functionality described above.

In one or more embodiments of the invention, signal blocking device (106) is a device that blocks, or severely limits wireless signals, such as those from wireless signal antenna (102) and wireless signal antenna (118). Signal blocking device (106) may block the wireless signals in any manner now known or later developed.

In one or more embodiments of the invention, kiosks (e.g., visitor kiosk (108) and/or inmate kiosk (114)) may be used by inmates, visitors, or others for communication, entertainment, and/or any other purpose. Visitor kiosk (108) and/or inmate kiosk (114) is a computing system with functionality to facilitate communication between an inmate and a visitor or outsider. Such communication facilitation may include creating a system identity data item or secure social networking account, adding or importing contact information for outsiders with whom the inmate wishes to communicate, uploading media (e.g., photos, videos, audio, and text) to, or viewing media from, a secure social network, sending or receiving messages or other media, acting as an endpoint for voice and video communication between an inmate and a visitor or outsider, scheduling a communication, and managing a commissary account. In one or more embodiments of the invention, visitor kiosk (108) is for visitors, while inmate kiosk (114) is inmates. Thus, visitor kiosk (108) and inmate kiosk (114) may have minor distinctions between them, such as increased use restrictions on inmate kiosk (114), and/or any other suitable modifications. Alternatively, visitor kiosk (108) and inmate kiosk (114) may be identical, except that inmate kiosk (114) is located in an area accessible to inmates. It will be apparent to one of ordinary skill in the art that visitor kiosk (108) and/or inmate kiosk (114) may have many different components and functionalities and, as such, the invention should not be limited to the above examples.

In one or more embodiments of the invention, the administrator application (110) is a process or group of processes executing on a computing system with functionality to enable an administrator to create, remove, and/or enforce one or more restrictions on an inmate. In one embodiment of the invention, an administrator is a person associated with the controlled facility charged with enforcing one or more restrictions. Examples of administrators include, but are not limited to, prison guards, orderlies, wardens, prison staff, jailers, information technology technicians, system administrators, and law enforcement agents. Using the administrator application, an administrator may retrieve or alter the identity data item and/or secure social network account of an inmate, visitor, or outsider. Further, in one or more embodiments of the invention, the administrator application (110) provides access to communications between inmates at the controlled facility (100) and visitors, outsiders, and other inmates. The administrator application (110) may also be used to monitor current voice or video calls between an inmate and a visitor, outsider, or other inmate. In one embodiment of the invention, the administrator application (110) may provide heightened access (i.e., a level of access greater than that of the inmate, visitor, or outsider) to data stored in the secure social networking account.

Specifically, the view administrator application (110) sees of the timeline will typically include access to all data normally hidden from visitor and inmate timelines, including all messages, photos (both approved and rejected), and a link to all video visitation archives and telephone call recordings, all of which are presented on the admin's view of the inmate's or visitor's timeline. This view of the timeline is a powerful investigator tool, allowing the admin to research and review all electronic communications a given person has had in relation to an inmate, parolee, or visitor of interest. This version of the application also provides real-time notifications (using the same push, IM, SMS, and MMS methods described above) of requests for visitation. Such notifications will typically contain the current results of the authorization checks described above. Using this information, the admin may approve, deny, or cancel a previously (automatically or human-) approved visitation request directly from within the application. In the case where the visitor's authorization check has indicated outstanding warrants (for arrest, as a person-of-interest in a criminal investigation, or other reason), the admin may elect to authorize said visitation request, and arrange with law enforcement officials to track the visitor using any GPS or other tracking information available on the device the visitor is using for the video visitation, or may modify the visitation, changing it to a request by the detainee for an in-person or on-site visit, or perhaps even a surprise release for medical reasons or good behavior, which would aid law-enforcement officials in apprehending the visitor with outstanding warrants, by encouraging the visitor to show up at the secure facility to collect the detainee.

In one or more embodiments of the invention, the local server (112) is a computer system or group of computers systems located within the controlled facility (100) that facility communication between inmates and visitors, outsiders, and/or other inmates. Specifically, the local server (112) may implement the software necessary to host voice and video calls between and among the visitor kiosk (108), the inmate kiosk (114), and a visitor mobile device (122). The local server (112) may also include functionality to enforce communication restrictions associated with the inmates using the inmate kiosk (114) or inmate mobile device (104). Alternatively, the local server (112) may merely provide access to other systems capable of hosting the communication software and data storage (e.g., located within an offsite facility or a third party provider). Further, in one embodiment of the invention, the local server (112) includes functionality to regulate inmate access to a secure social network.

In one or more embodiments of the invention, the elements within the controlled facility (100) are communicatively coupled to the communications network (116). In one embodiment of the invention, the communications network (116) is a collection of computing systems and other hardware interconnected by communication channels. The communications network (116) may include networks that are exclusively or primarily used for a single type of communication, such as a telephone network (e.g., Public Switched Telephone Network (PSTN) or Plain Old Telephone System (POTS)), and/or networks used for a wide array of communication types, such as the Internet through Voice over IP (VoIP). Communication channels used by the communications network (116) may include, for example, telephone lines, networking cables, wireless signals, radio waves, etc. Fees charged and payments received by the provider(s) of the communications network (116) may involve multiple parties, including a service provider, the management of the controlled facility (100), and provider(s) of the communications network (116). In one or more embodiments of the invention, fees may be split between multiple parties based on the terms of underlying agreements or contracts between the parties. Further, rebates, reimbursements, and/or refunds may be afforded to and paid to the management of the controlled facility (100) based on the terms of underlying agreements or contracts between the parties. For example, the management of the controlled facility (100) may receive a rebate from the service provider of the services provided to inmates based on such factors as the volume of use, the dollar amount, and/or the frequency of use.

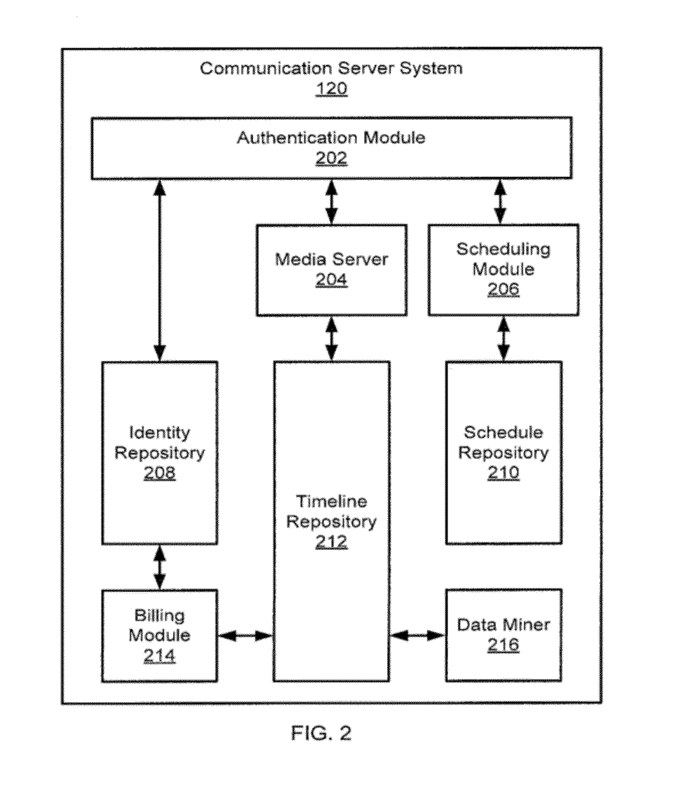

In one or more embodiments of the invention, communication server system (120) is any server, computer, rack, desktop computer, laptop computer, or other suitable computing device. Communication server system (120) is discussed in more detail in FIG. 2.

In one or more embodiments of the invention, visitor mobile device (122) is any suitable mobile device, such as a smart phone, laptop, tablet, etc. Specifically, visitor mobile device (122) is able to communicate with inmate mobile device (104), authenticate the visitor, and/or any other functionality for communicating with an inmate. Visitor mobile device (122) may execute a visitor application that provides the functionality discussed above.

Optionally, the system of FIG. 1 may include an application for victims of a crime (not shown). The application is intended for use by crime victims and others who may feel threatened by a particular inmate (such as judges, jurors, police officers, etc.) allows such victims and other individuals to subscribe to information about specific incarcerated and formerly incarcerated individuals, ideally anonymously, and be notified automatically by the application, preferably using push notification, of events relating to the incarcerated or formerly incarcerated individual. These events may include, but are not limited to, parole hearings, trial dates, release dates, new arrests, new charges, and anything else in the public record that may serve to increase the safety and/or peace-of-mind of the anonymous user.

For instance, if a formerly incarcerated individual is subject to a keep-away restraining order, and the anonymous victim chooses, the application may indicate an alert whenever available tracking systems (such as a GPS ankle band or a handheld computing device with tracking features enabled, such as a mobile phone configured for parolee monitoring) indicate the subject of the restraining order has come within a specified distance of the protected individual. Upon this alert, the authorities responsible for the person subject to the restraining order may be automatically notified of the violation, and/or the protected individual may be given instructions on which direction will increase the distance between him and the subject bound by the restraining order.

FIG. 2 shows communication server system (120) in detail, in accordance with one or more embodiments of the invention. Communication server system (200) includes authentication module (202), media server (204), scheduling module (206), identity repository (208), schedule repository (210), timeline repository (212), billing module (214), and data miner (216).

In one or more embodiments of the invention, authentication module (202) authenticates/verifies inmates, visitors, outsiders, and/or anyone communicating using this invention. Specifically, the authentication may take may different forms including voice, picture/video, passwords, fingerprints, and/or any other method of verifying identities and/or authenticating individuals. Authentication module (202) may utilize a voice ID audio clip that was previously recorded by the inmate. The pre-recorded clip can be recorded under the supervision of administrative staff, and may be, for example, a recording of an inmate stating their name or another short phrase. When authentication is needed, the inmate is requested to speak the pre-recorded phrase. After speaking the phrase and being authenticated, the inmate may log into the system. The authentication module (202) records the phrase spoken by the inmate, and compares a digital signature of the audio to the pre-recorded audio clip. The pre-recorded clips may be created and stored locally at the kiosk or mobile device, or may be created by another mechanism and stored at, for example, a database. Accordingly, the comparison may be made by software on the kiosk or at the processing center. If the recorded audio matches the prerecorded audio clip, the inmate is granted access.

In one or more embodiments of the invention, authentication module (202) is able to use facial verification either separately or in combination with one or more of the other verification systems, including Personal Identification Number (PIN) verification and the voice verification. For facial verification, the inmate may line up their eyes with the eye level marks displayed on the kiosk or mobile device. This ensures that an appropriate image is captured for verification.

As with voice verification, facial verification processing may be performed locally or remotely. In either case, the facial verification processing includes comparing an image captured by a camera with a pre-stored image of the inmate. Authentication module (202) may use facial “landmarks” generated by mathematical formulas to present a score which indicates a likelihood that the captured image matches the pre-stored image. If the images match to a sufficient degree, the verification is approved and the inmate is granted access to the system. If the images do not match, the system may store the captured image and other usage details for review by administration officials.

In one or more embodiments of the invention, media server (204) is a computing system or group of computing systems with functionality to provide network application services to facilitate communication between an inmate and an outsider, and to facilitate access to a secure social network. Such services include, but are not limited to, voice-over-internet-protocol (VoIP) services, video conferencing services, and media streaming services.

In one or more embodiments of the invention, scheduling module (206) is responsible for scheduling communications involving inmates. For example, requests for scheduled or immediate remote or on-site video visitations may be made at or by any kiosk, mobile device, or other suitable computing device. Scheduling module (206) handles the scheduling in conjunction with authentication module (202), discussed above. Once arranged, authorized, and connected, the audio and video portions of the remote visit are handled by and travel through the media server (204).

In one or more embodiments of the invention, identify repository (208) is used to store authentication information created and/or used by authentication module (202).

In one or more embodiments of the invention, schedule repository (210) is used to store scheduling information created and/or used by scheduling module (206).

In one or more embodiments of the invention, timeline repository (212) is a repository for data relating to a social networking site associated with this inmate. Timeline repository (212) may not display every item stored on it on a timeline of an associated inmate, some items may be rejected or withheld based on a variety of factors. In one or more embodiments of the invention, timeline repository (212) stores, for example, data about a video visitation after the conclusion of the visitation. The data stored may include the date and start time, duration, and profile photos of the parties communicating may be posted to the social networking “wall” or- “timeline” for each participant. As secure environments rarely, if ever, permit either visitors or inmates to view recordings of past video visitations, even though such visitations are typically recorded and archived for use by investigators, the actual video of the visitation is typically not included in said timeline. However, during a video visitation, both parties may be allowed to engage in instant messaging (IM) types of chats. These may be optionally included in the parties' timelines, if permitted by facility rules.

In one or more embodiments of the invention, timeline repository (212) may store electronic text messages and/or photos exchanged between detainees and visitors, optionally for a fee. These will typically be entered into a review queue, instead of being immediately displayed on the social networking timeline. Such messages and/or photos will typically need approval by a suitably authorized individual working at or on behalf of the secure facility. If and when approved, these messages and/or photos may then be displayed on the visitor and/or inmate timelines.

Additionally, the visitor is provided the means of cross-posting photos uploaded to timeline repository (212) to common publicly available social networking services, such as but not limited to Facebook, FourSquare, and Flickr. These photos may be posted only if sufficient funds and permission are available to the visitor, and will typically be held in the aforementioned review queue before being posted on, even if they are immediately posted to the public service such as Facebook, FourSquare, or Flickr. As posted there, they may or may not have any indication that they were taken or uploaded in conjunction with an inmate. As is frequently practiced with photos uploaded to such social networking sites, such photos will often have geographic coordinates or other data associated with them, either by means of a GPS or similar position-determining device or service, or by means of manual input, or by a combination of both methods (as is practiced in the FourSquare service, where the GPS position is used to display a list of nearby well-known business locations or other points-of-interest). Such information will often be of interest and value to the inmate, the visitor, and also the facility's investigators.

In addition to the human-generated content, timeline repository (212) may also include automatically generated content related to the inmate, such as dates of upcoming court appearances, parole hearings, release or parole dates, and other such items. These items may be displayed both in the timeline as a historical record, and in a separate list that highlights upcoming events. Additionally, when any of these dates are initially scheduled, that event may be recorded in the timeline.

In one or more embodiments of the invention, In one or more embodiments of the invention, the billing module (214) is responsible for payments made for or using a mobile device. Optionally, the functionality associated with the billing module (214) may be located on any other suitable component. Billing module (214) may facilitate an inmate making payments from the prisoner's commissary or communications account, or any other account allowed by the prison or controlled facility including, but not limited to: checking accounts, savings account, credit cards, gift cards, online payment accounts, and/or any other account. In one or more embodiments of the invention, family or friends of the inmate may place funds into a special account strictly for payment of fees associated with a mobile device, which the inmate may then access for payment of any fees associated with a mobile device or the usage of a mobile device.

In one or more embodiments of the invention, data miner (216) is an application or module for use by administration, investigators, and other similar people. Data miner (216) comprises functionality for mining data stored on Communication Server System (120) and is typically used for investigating crimes, criminal behavior, rule breaking, safety issues, and/or any other reasons. In one or more embodiments, the functionality described for data miner (216) may be associated with a different application or device, such as administrator application (110).

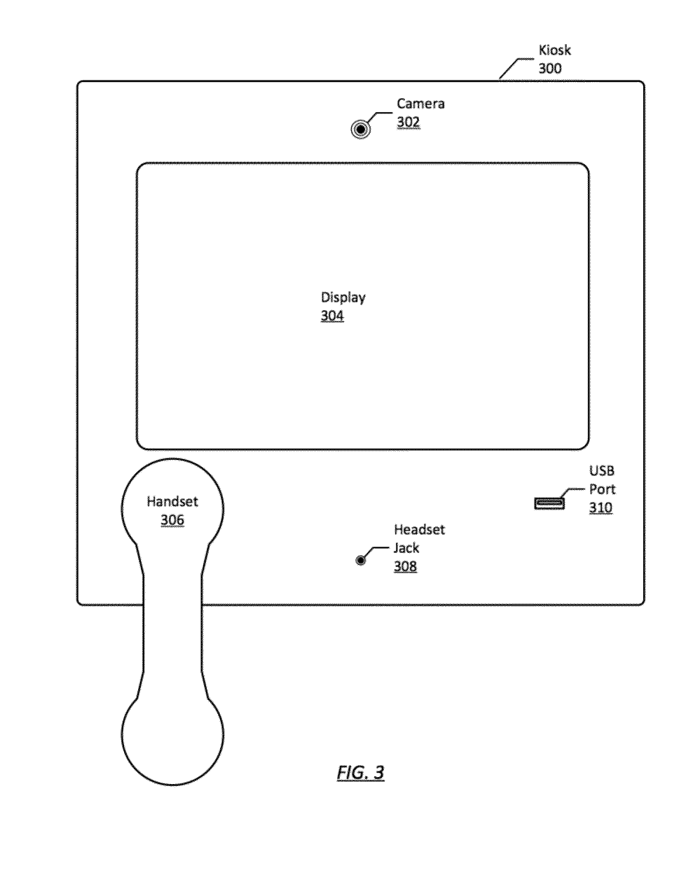

FIG. 3 shows kiosk (300) in accordance with one or more embodiments of the invention. Kiosk (300) includes an integrated camera (302) that can be used for video communications or for user authentication via facial recognition. The kiosk also includes a display (304) that displays images and may be able to detect the presence and location of a user's touch within the display area. Display (304) may be, for example, a 15-inch capacitive or resistive touch screen display. The touch screen serves as the main kiosk interface with a user. A telephone handset (306) connected to the kiosk includes a speaker (not shown) and a microphone (not shown). Handset (306) can be used to issue voice commands and provide voice authentication as required, or it can be used for voice and video communications, among other things. Handset (306) is just one possible embodiment of audio capture and playback, as a kiosk user may, for example, instead plug in a headphones or headset with an in-line microphone using one or more headphone jack (308), or may use a speakerphone (speaker and microphone combined with additional audio processing hardware) (not shown). Headphone jack (308) may also be located on the side of the kiosk or behind a movable panel, which can be locked in a position exposing the jacks or in a position blocking them, depending on the preferences of the facility. In one or more embodiments of the invention, USB port (310) is located behind a movable panel and can be used for system diagnostics by technicians or to synchronize files to an external device, such as a portable media player. The kiosk also includes a speaker (not shown) that provides audio output.

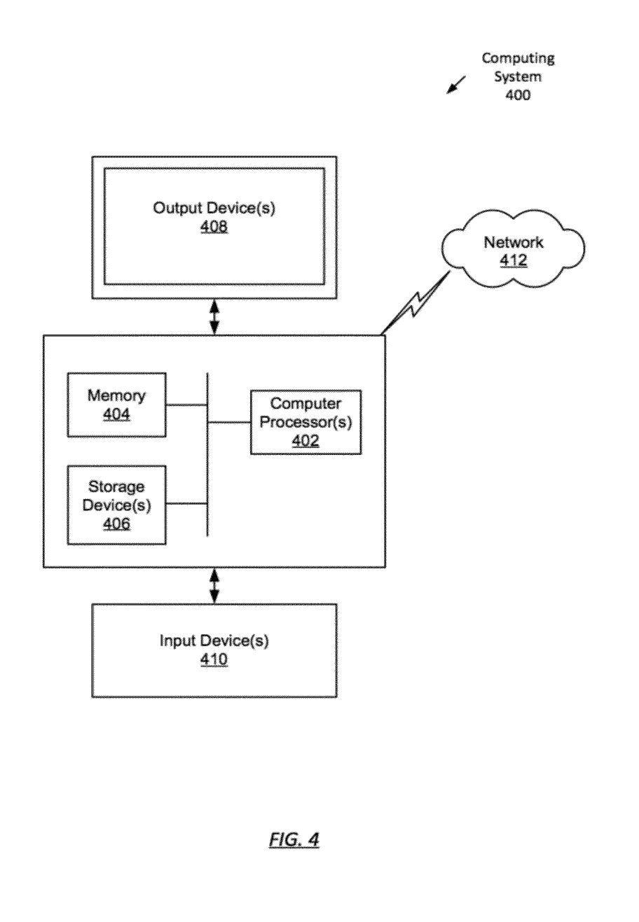

While FIG. 3 shows kiosk (300) as a wall-mountable kiosk, other structural forms, enclosures, or designs are possible. Kiosk (300) may be any shape or size suitable to providing the described components and services. Kiosk (300) may be, for example, a standalone structure, a personal computer, a laptop, a mobile device, or a tablet computer device. If kiosk (300) is in the form of a laptop, mobile device, or tablet computer, it may be a ruggedized device designed to withstand physical shock, and may be integrated with a docking system that connects to the device for locking, storage, display, additional connectivity and/or charging. Kiosk (300) may be tethered to a structure by known methods, such as a security lock cable. Further, kiosk (300) may include any of the components described below in FIG. 4.

FIG. 4 shows a general computing system in accordance with one or more embodiments of the invention. As shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (414) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

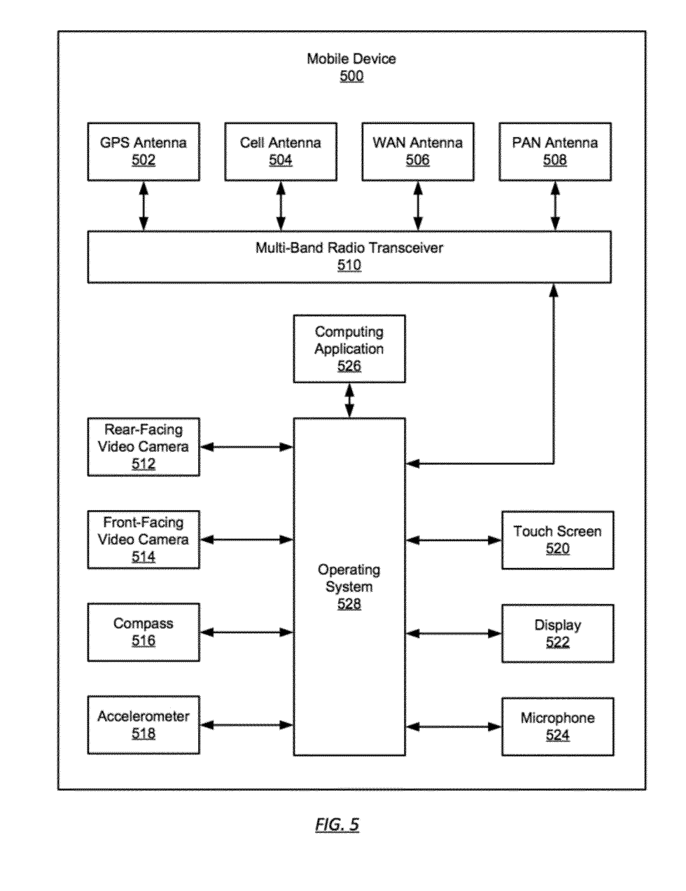

FIG. 5 shows the hardware and software elements of a mobile computing device in accordance with one or more embodiments of the invention. Specifically, the mobile device (500) is a portable device that provides a user interface. Examples of mobile devices may include, but are not limited to, cellular phones, personal digital assistants, personal communicators, pagers, smart phones, or any other computing device. The hardware and software elements shown in FIG. 5 may be in addition to the elements described in FIGS. 3 and 4.

As shown in FIG. 5, the mobile computing device (500) includes a global positioning system (GPS) antenna (502), a cell antenna (504), a wide area network (WAN) antenna (506), and a personal area network (PAN) antenna (508), each connected to a multi-band radio transceiver (510). GPS antenna (502) includes functionality to obtain a location coordinate of the mobile computing device (500). Mobile computing device (500) may be configured to use the GPS antenna (502) to provide latitude and longitude location coordinates. In one or more embodiments of the invention, the network connection (i.e., via antenna (402), cell antenna (504), WAN antenna (506), PAN antenna (508), and/or multi-band radio transceiver (510)) may be facilitated by a wireless infrastructure (not shown), including one or more transceivers cooperating to facilitate wireless communications to wireless devices. The wireless infrastructure may include one or more routers, switches, microwave links, base stations, optical fibers, or other similar networking hardware or software components. For example, the wireless infrastructure may be a paging network, a cellular network, etc.

The mobile computing device (500) also includes a rear-facing video camera (512), a front-facing video camera (514), a compass (516), an accelerometer (518), a touch screen (520), a display (522), and a microphone (524), all of which may include any functionality or features now known or later developed. The mobile computing device (500) also includes a computing application (526) executing on an operating system (528).

Network connections to device (500) are preferably configured to ensure device (500) may only connect to authorized access points and also to only receive, or perhaps transmit, authorized content. This may be achieved, in various embodiments, via security access control software. All network traffic is typically processed by the security access control software, and requests and responses that meet predefined requirements are allowed to pass.

The security access control software may be configured for locking down WiFi and other inmate network connections. The security access control software may run on, for example, an Enterprise Linux and is comprised of dedicated, purpose-built layers that allow secure connections between a wide range of devices, such as device 500, and other devices, and the Internet.

The security access control software typically includes:
Proxy Server: Typically utilized to inhibit a direct connection between any device on the network and any 3rd Party servers. Instead, the security access control software acts as a proxy, making requests for each device and funneling responses (that meet predefined criteria) back to each device.
Internet Whitelist: Access is typically limited to pre-approved URLs. Standard restrictions, such as IP, port, and wildcard filtering may also be implemented. These whitelists may be controlled on a per facility basis. Whitelist are typically implemented for access via a Web browser.
Firewall: The firewall blocks any outside systems from initiating contact with devices. The firewall also limits the ports and protocols that are available.
Access Control: Authenticates inmate PINs and controls access privileges.

Advantageously, the security access control software is able to prevent access to any blocked-type, or unauthorized, type of communication. Authorized communications and whitelisted content are allowed to pass through. Alternatively a blacklisted implementation could also be implemented.

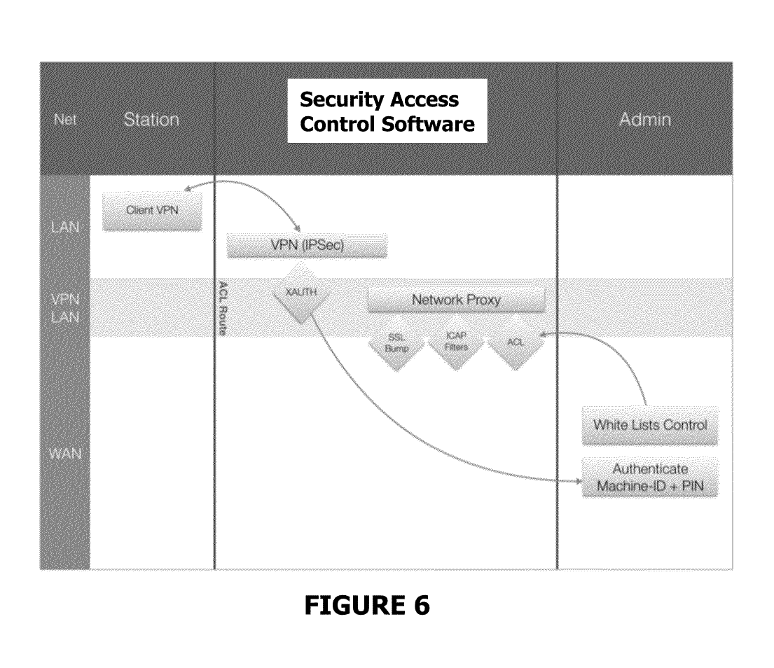

FIG. 6 illustrates security access control software network layers 600 as data is passed to and from a device 500. The security access control software typically employs a VPN connection between all networked devices (desktop computers, laptops, tablets, etc.) and the wireless router or routers assigned to it. xAuth is used to authenticate the networked device, allowing a connection to take place. Next all networked traffic is processed by a network proxy, which utilizes white list controls (allowed destination and source lists) which may be applied to a single device, group of devices, or all devices. Additionally, SSL connections are handled by the network proxy, ensuring that secure keys and connections are under the control of the proxy, which allows the proxy to read, understand, and regulate SSL-encrypted network traffic.

The following table is an example overview of the security access control software's network layers:

| Layer | Access |
|---|---|
| LAN | DHCP Security, DNS Masking, IPSec VPN Server |
| VPN LAN | Transparent Network Proxy, Audit Service |
| Network Proxy | Filtered Requests and Responses |
| Intranet | Only whitelisted addresses are accessible on any intranet |
| Internet | Only whitelisted addresses are accessible on the internet |

The security access control software controls will typically include the following features:
VPN Session Control: Every session is typically tied to an inmate's unique PIN.
Content Filtering: Requests and responses may be block and/or flagged based on content filters.
Access Logs: All network access by all inmates is viewable and controllable by facility staff at any time.
Additional Whitelist Controls: In addition to blocking requests to URLs that do not match a whitelist, requesting software may be redirected to pre-defined alternative, destinations. For example, if a user were to attempt to access a subsection or subdomain of a site that is not permitted, the request could be redirected to the site's permitted home page, or alternately to a page that explains that the request was not allowed and suggesting alternative allowed destinations.

Regarding VPN session control, in one embodiment, connections between a device 500 and an access point is successful when the device 500 presents a valid combination of the device's 500 MAC address and device ID of device 500.

Advantageously, the security access control software typically includes the following threat avoidance measures:

No Spam or Phishing: There's no direct email access allowed.

No Device-to-Device communication

No File Transfers: No FTP, BitTorrent etc. HTTP connections are filtered.

Bandwidth Managed: Any attempt to flood or clog the network is will be and thus prevented.

Secure by Default: Failure of any component in the network will typically not result in privilege escalation.

The security access control software may be configured via a web-based interface that in some implementations is also configured to control other telecommunication services. Control includes allowing or preventing a wide range of protocols to individual devices on the network, groups of devices, individual users of those devices, groups of users, or across a facility or the entire organization.

The security access control software supports a wide range of features for staff ranging from features for investigators to network administrators. These features may include:
Overview of device usage by inmate, groups of inmates, device and groups of devices;
Details logs of inmate and device usage;
Full inmate access control (change, update privileges);
The ability to manage the whitelisted URLs by computer, by group, by—inmate, by groups of inmates, or even entire facilities, subsets of a group of facilities or even an entire group of facilities;
Realtime view and control of access from each device/inmate; and
Alarms/alerts for unauthorized access attempts.

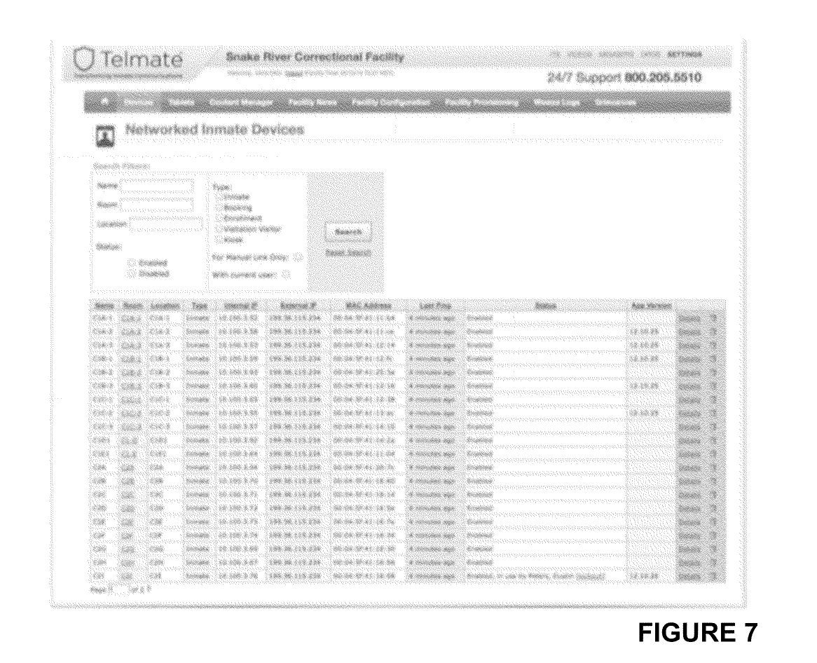

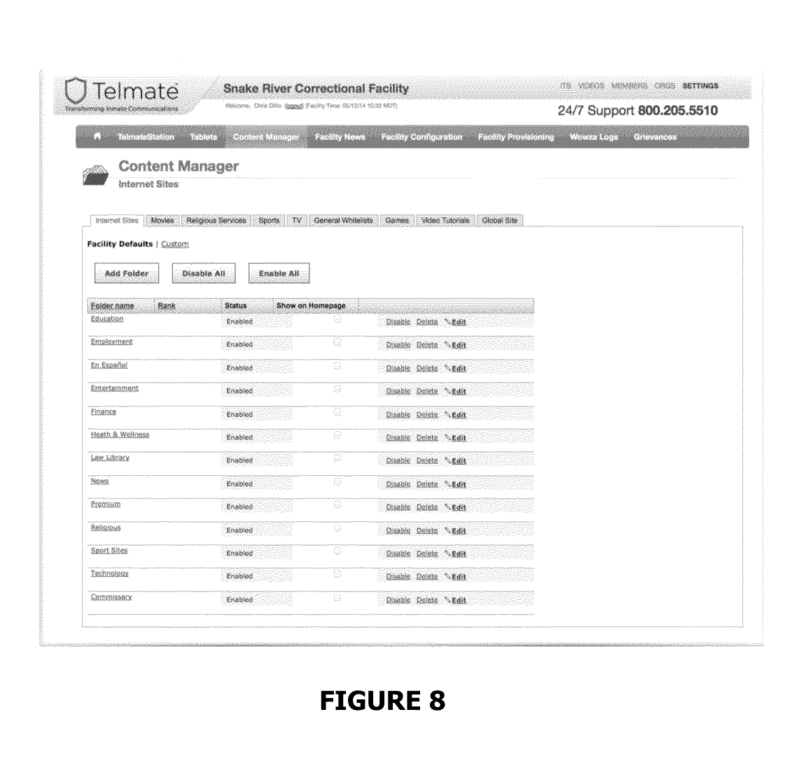

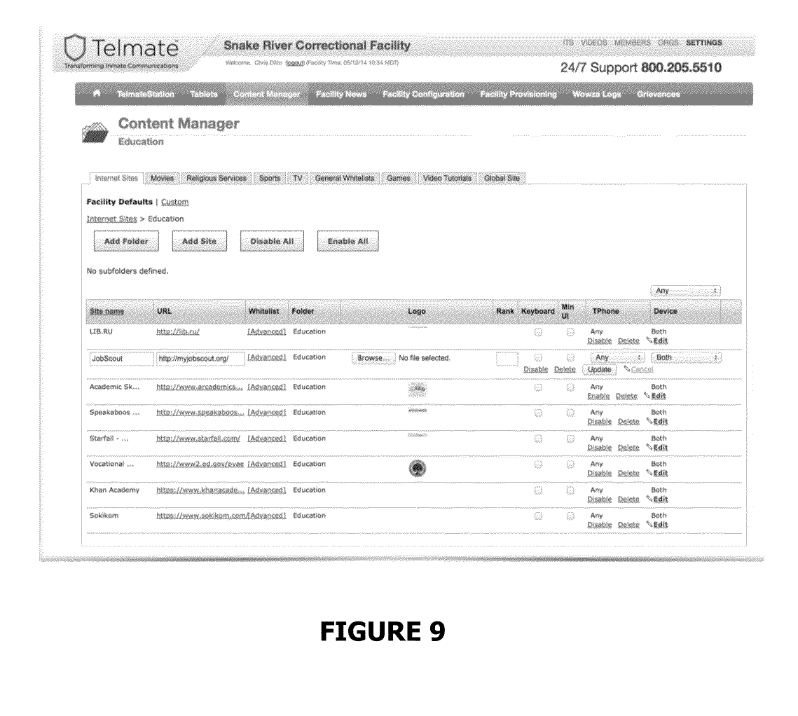

FIG. 7 is a screenshot of a Web overview of inmate networked devices at a single facility. The Type filter below will include additional equipment reflecting the equipment proposed here. FIGS. 8-9 are screenshots of Internet configuration, allowing the creation of categories of sites, and URL patterns for allowed URLs.

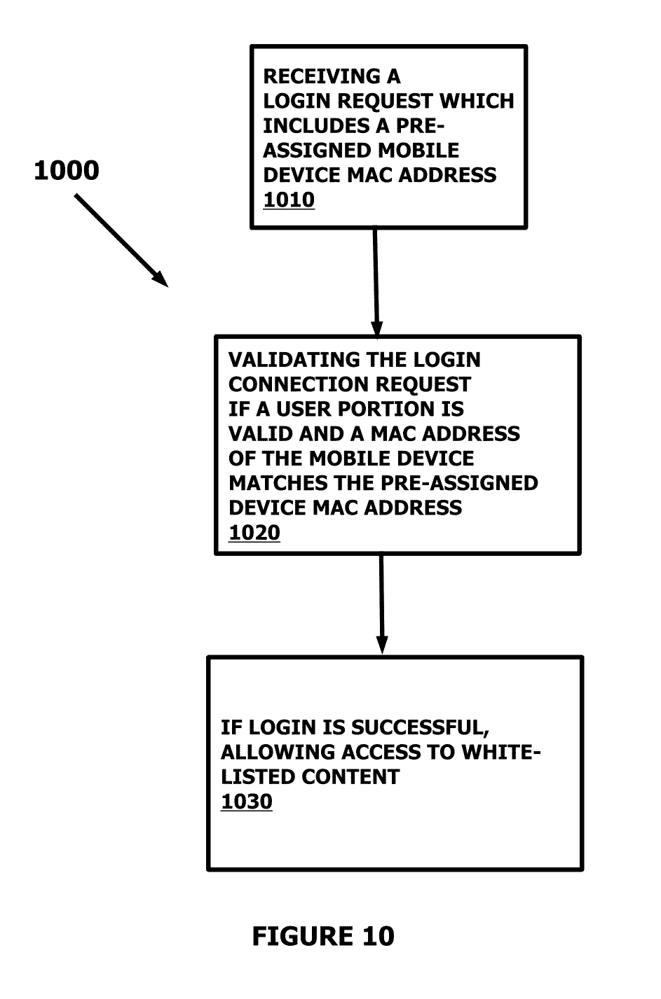

FIG. 10 is a flowchart diagram illustrating a method 1000 for VPN-based mobile device security. The method includes receiving (1010) a login connection request from a mobile device that includes a login credential based in part on a pre-assigned mobile device MAC address and validating (1020) the login connection request if a USERID portion of the login credential matches to a registered user and if the pre-assigned MAC address portion of the login credential matches a MAC address of the mobile device that sent the login connection request. Also, if the login connection request successfully validates, allowing access to white-listed content (1030).

While a number of exemplary aspects and embodiments have been discussed above, those of skill in the art will recognize certain modifications, permutations, additions and sub-combinations thereof. It is therefore intended that the following appended claims, and claims hereafter introduced, are interpreted to include all such modifications, permutations, additions and sub-combinations as are within their true spirit and scope.

What is claimed is:

1. A method for providing VPN-based mobile device security comprising:
receiving a login connection request from a mobile device that includes a login credential based in part on a pre-assigned mobile device MAC address;
validating the login connection request if a USERID portion of the login credential matches to a registered user and if the pre-assigned MAC address portion of the login credential matches a MAC address of the mobile device that sent the login connection request; and
if the login connection request successfully validates, allowing access to white-listed content.

2. The method as recited in claim 1 wherein if the login connection request successfully validates, allowing access to black-listed content.

3. The method as recited in claim 1 wherein if the login connection request successfully validates, allowing access to categorized content.

4. The method as recited in claim 1 wherein if the login connection request successfully validates, allowing access to content matching one or more URL patterns.
